(19) United States
(12) Patent Application Publication
(10) Pub. No.: US 2014/0103068 A1
(43) Pub. Date: Apr. 17, 2014

(54) CONTENTS REFILLABLE PAPER TUBE CONTAINER

(71) Applicants: Su-Jin Son, Incheon (KR); Shin-Bok Jung, Incheon (KR); Mi-Hee Park, Incheon (KR)

(72) Inventors: Su-Jin Son, Incheon (KR); Shin-Bok Jung, Incheon (KR); Mi-Hee Park, Incheon (KR)

(21) Appl. No.: 14/124,368

(22) PCT Filed: Jul. 2, 2012
(86) PCT No.: PCT/KR2012/005242

§ 371 Date: Dec. 6, 2013

(30) Foreign Application Priority Data
Jun. 30, 2011 (KR) 10-2011-0064377

(51) Int. Cl. B65D 35/56

(52) U.S. Cl. CPC B05B 11/3047; B05B 15/061
USPC 222/105; 222/183; 222/321.7

(57) ABSTRACT

A contents refillable paper tube container enables: a pumping member to be combined with a paper body in a detachable manner; and a combination part to be formed on the lower part of the pumping member in order to replace a pouch, thereby reducing manufacturing costs and shortening manufacturing time since the pouch can be fixed and replaced through a simple structure.

### BACKGROUND

The present invention relates to a contents refillable paper tube container, and in particular to a contents refillable paper tube container which makes it possible to reduce a manufacturing cost and time thanks to an improved pouch which can be fixed in a simple-looking structure and can be easily exchanged in such a way that a pumping member is detachably engaged to a body made from paper and an engaging portion is formed at the bottom of the pumping member in order for the pouch to be exchanged.

Shampoo, rinse, cosmetic products are sold with their contents being stored in containers. Some of such products are sold in a pouch form at cheaper prices for the sake of recycling.

When refilling a certain content, a user squeezes the contents out of a pouch into a container designed for shampoo, rinse, cosmetics, etc. when in use so as to save costs. During the above mentioned procedures, the user needs to cut off part of the pouch and squeezes out the contents and refills them into the container, which may, however, causes any inconveniences to the user.

In order to overcome the above problems, the Korean Utility Model No. 20-0282756 whose title is “refillable cosmetic container” (hereinafter referred to “registered utility model”) is disclosed.

The above mentioned registered utility model has features in that in the cosmetic container formed of a container body into which contents are filled, and a lid which is thread-engaged to the container body, there are provided an outer container 10 configured in such a way that a hole 11 into which an opening 22 of an inner container 20 is formed at the top in a tubular shape, and a thread portion 12 is formed at an outer surface of the bottom where a shoulder is formed from an outer side to an inner side so that a finishing cap 30 can be thread-engaged to the thread portion 12, and a groove 13 into which a protrusion 23 formed at both outer sides of the bottom of an inner container 20 is cut at the bottom where the threads are formed; an inner container 20 which has a content accommodation body 21 with a certain diameter corresponding to the inner diameter of the outer container 10 and a length corresponding to its inner length, a protrusion 23 formed at a lower outer portion of the content accommodation body 21 and inserted into the groove 13 formed at the bottom of the outer container 10, and an opening 22 inserted into the hole 11 of the outer container 10 and thread-engaged to the cap 40; and a finishing cap 30 which helps fix the refilled inner container 20 with the outer container 10 as the inner container 20 is thread-engaged to the threads 13 formed at the bottom of the refilled outer container 10.

The above mentioned Korean registered utility model is directed to providing a structure which can be recyclable so that the inner container 20 storing contents can be recycled. For this, the groove 13 and the protrusion 23 are formed in each container for fixing the outer container 10 and the inner container 20, and the finishing cap 30 is engaged to the threads 12 formed at the bottom of the outer container 10, the whole constructions of which look complicated and cost a lot and are time-consuming to manufacture.

In order to overcome the above mentioned problems, the same inventor as the present application filed on Jul. 31, 2009 an invention with the Korean patent application No. 10-2011-0012781 (hereinafter referred to “laid-open patent”).

In the above mentioned application, there are provided a paper tube body with a space in which to store contents, a fixing part which is engaged to the top of the inner side of the paper tube body and has a protrusion along an upper outer surface, a pouch which is engaged to the bottom of the fixing part and stores contents and is detachably attached to the fixing part for exchange when the contents are all consumed, a pumping member which is engaged to the top of the fixing part and discharges the contents from the pouch to the outside through the pumping operation and is detachable from the paper tube body, and a paper tube cap which is engaged to the top of the paper tube body.

The above described laid-open patent, however, has an engaging shoulder formed by engaging a paper tube to the inner side of the paper pipe body for fixing the fixing part and a protrusion formed at an outer surface of the fixing part so that it can be fixedly mounted on the engaging shoulder, the constructions of which look complicated, and the manufacture costs a lot and is time consuming.

Since the pouch is attached to the outer surface of the engaging part, the pouch may be detached from the engaging part by means of the pressure of the contents when filling the contents.

### SUMMARY OF THE INVENTION

Accordingly, the present invention is made so as to improve the above mentioned problems. It is an object of the present invention to provide a contents refillable paper tube container which makes it possible to reduce a manufacturing cost and time thanks to an improved pouch which can be fixed in a simple-looking structure and can be easily exchanged in such a way that a pumping member is detachably engaged to a body made from paper and an engaging portion is formed at the bottom of the pumping member in order for the pouch to be exchanged.

It is another object of the present invention to provide a contents refillable paper tube container which makes it possible to prevent a pouch from being disengaged from a fixing part by means of the pressure of the contents when filling the contents in such a way to provide a pressurization part which pressurizes and fixes the pouch at the top of the fixing part and makes it possible to prevent the pouch from being damaged by means of distortion due to the rotations when the fixing part and the engaging part are thread-engaged.

To achieve the above objects, there is provided a contents refillable paper tube container, comprising a paper tube body 100 which is made from a paper material and has a space in which to store contents; a pumping member 200 which has an engaging groove 110 mounted on the top of the paper tube body 100 while covering the top of the paper tube body 100 and being detachable from the paper tube body 100 and has an engaging part 220 formed at its lower side and having threads 221, for thereby discharging contents to the outside through a pumping operation as a user pressurizes; a pouch part 300 which stores contents and is detachable from the engaging part 220 for the sake of its exchange when the contents are all consumed; and a paper tube cap 400 which is made from a paper material and is engaged covering the pumping member 200 at the top of the paper tube body 100.

In addition, the pouch part 300 comprises a pouch 310 which stores contents; a fixing part 320 which supports the pouch 310 and has an opening 321 at its center for charging contents through the opening 321 and threads 322 formed at its outer surface for a thread engagement to the engaging part 220; and a pressurization part 330 which is engaged to the opening 321 at the top of the fixing part 320 and has a hollow portion 331 for charging contents.

In addition, the top of the pouch 310 is mounted on the top of the fixing part 320 and is fixed as the pressurization part 330 pressurizes.

In addition, a fixing shoulder 323 is formed at the top of the fixing part 320 so as to prevent the pouch 310 from being disengaged, and a pressurization protrusion 332 is formed at the pressurization part 330 for pressurizing and fixing the pouch 310.

The contents refillable paper tube container according to the present invention makes it possible to reduce a manufacturing cost and time thanks to an improved pouch which can be fixed in a simple-looking structure and can be easily exchanged in such a way that a pumping member is detachably engaged to a body made from paper and an engaging portion is formed at the bottom of the pumping member in order for the pouch to be exchanged.

In addition, the contents refillable paper tube container according to the present invention makes it possible to prevent a pouch from being disengaged from a fixing part by means of the pressure of the contents when filling the contents in such a way to provide a pressurization part which pressurizes and fixes the pouch at the top of the fixing part and makes it possible to prevent the pouch from being damaged by means of distortion due to the rotations when the fixing part and the engaging part are thread-engaged.

### BRIEF DESCRIPTION OF DRAWINGS

FIG. 1 is a disassembled cross sectional view illustrating a construction of the contents refillable paper tube container according to a preferred embodiment of the present invention.

FIG. 2 is an engaged cross sectional view illustrating a construction of the contents refillable paper tube container according to a preferred embodiment of the present invention.

FIG. 3 is a view for explaining a use state of the contents refillable paper tube container according to a preferred embodiment of the present invention.

### DETAILED DESCRIPTION OF THE INVENTION

The preferred embodiments of the present invention will be described with reference to the accompanying drawings. It is noted that throughout the specification, the same reference numerals mean same elements.

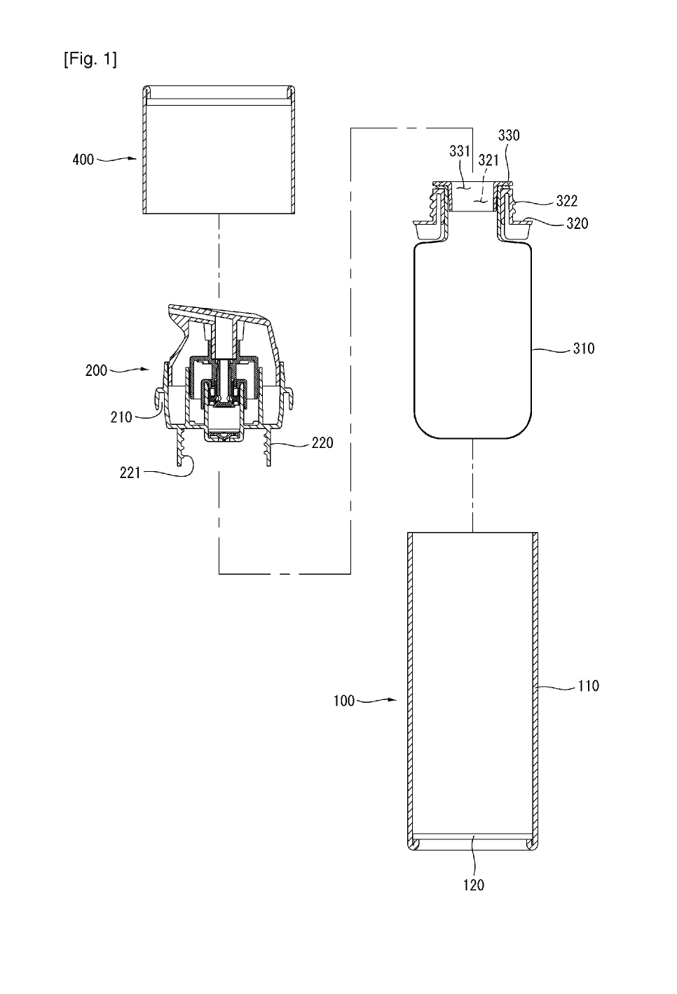

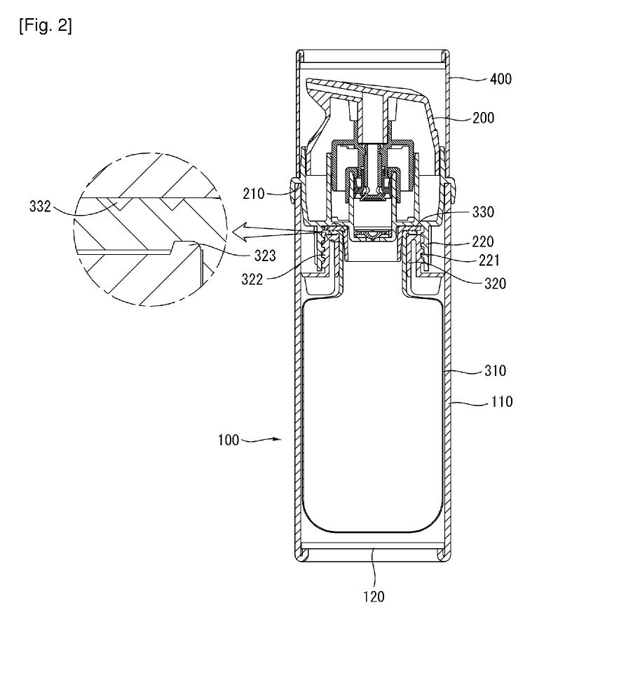

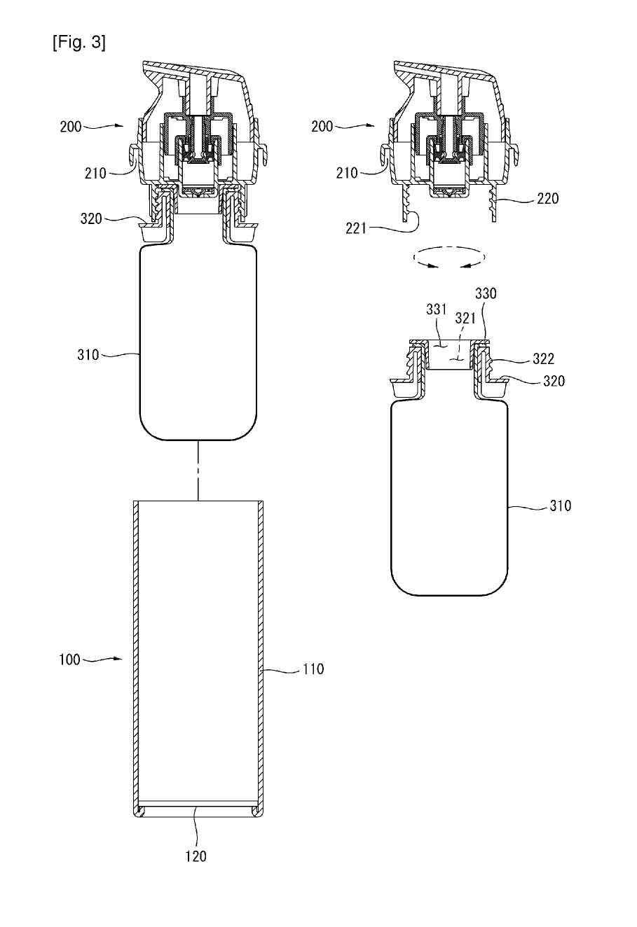

FIG. 1 is a disassembled cross sectional view illustrating a construction of the contents refillable paper tube container according to a preferred embodiment of the present invention. FIG. 2 is an engaged cross sectional view illustrating a construction of the contents refillable paper tube container according to a preferred embodiment of the present invention. FIG. 3 is a view for explaining a use state of the contents refillable paper tube container according to a preferred embodiment of the present invention.

As sown in FIGS. 1 to 3, the contents refillable paper tube container according to a preferred embodiment of the present invention comprises a paper tube body 100, a pumping member 200, a pouch part 300 and a paper tube cap 400.

The paper tube body 100 is equipped with a space in which to store contents and is formed of a paper tube part 110 forming a side surface and a support part 120 which is formed at the bottom of the paper tube part 110 for thereby opening and closing the bottom.

The present invention has features in that the paper tube body 100 is made from a paper material. The pumping member 200 is interference fitted with a user's pressurization, so the work for manufacturing an engaging member which is used for an engagement between members of a container can be omitted in the middle of the manufacture of the cosmetic container for thereby reducing manufacture time and costs.

Since the paper tube body 100 is made from a paper material, a character, an image and a symbol can marked on its outer surface or a post-process for providing various colors can be easily performed, for thereby reducing defective products.

Since the paper tube body 100 is made from a paper material, the paper tube body can be recycled, thus preventing environment destruction.

The pumping member 20 is engaged, covering the top of the paper tube body 100, for thereby discharging to the outside the contents stored in the pouch part 300 through the pumping operations. It is preferred that an engaging groove 210 is formed at a portion contacting with the top of the paper tube body 100 and is engaged to the paper tube body 100.

In the present invention, the pumping member 200 is detachable from the paper pipe body 100. The pumping member of the cosmetic container is reliably fixed by way of a fixing member like a support cap fixing the pumping member; however the pumping member 200 of the present invention can be detachable from the paper tube body 100 by a user's pressurization for the pouch part 300 to be easily exchanged if necessary.

In the present invention, at the bottom of the pumping member 200 is provided an engaging part 220 with a thread 221 which is engaged with the fixing part 320 of the pouch part 300.

The pumping member 200 is thread-engaged to the fixing part 320 of the pouch part 300 through the engaging part 220, so when the user disengages the pumping member 200 from the paper tube body 100, the pouch part 300 disengages together. The pouch part 300 can be exchanged as the thread engagement between the engaging part 220 and the fixing part 320 is disengaged.

When the exchange of the pouch part 300 is finished, the user holds the pumping member 200 and engages it to the paper tube body 100. At this time, while the pumping member 200 is slowly engaged to the paper tube body 100, the engaging groove 210 of the pumping member 200 is mounted on the top of the paper tube body 100 and is engaged to the paper tube body 100.

Since the constructions applied to the pumping operations of the pumping member 200 are known in the art, the descriptions thereof will be omitted.

The pouch part 300 stores contents and is detachably engaged to the engaging part 220 for the sake of its exchange when the contents are all consumed and comprises a pouch 310 for storing contents, a fixing part 320 which supports the pouch 310 and has an opening 321 at its center for filling or discharging the contents and threads 322 at its outer surface for a thread engagement to the engaging part 220, and a pressurization part 330 which is engaged to the opening 321 at the top of the fixing part 320 and has a hollow portion 331 for filling or discharging the contents.

In the present invention, the top of the pouch 310 comes into close contact with the inner surface of the fixing part 320, the end portion of which being mounted on the top of the fixing part 320 and being fixed by means of the pressurization of the pressurization part 330. For the sake of the reliable fixing of the pouch 310, a fixing shoulder 323 is formed at the top of the fixing part 320 in order to prevent the pouch 310 from being disengaged. A pressurization protrusion 332 is formed at the pressurization part 330 for pressurizing and fixing the pouch 310.

The pouch 310 is fixedly supported by the fixing part 320 with the aid of the pressurization of the pressurization part 330, so the pouch 310 can be prevented from being disengaged from the fixing part 320 when fixing the contents into the pouch 310.

The pressurization part 330 is so positioned that the pouch 310 is not exposed to the outside in such a way to pressurize the top of the pouch 310. Consequently, the pouch 310 can be prevented from being damaged for it is distorted by rotations when thread-engaging the pouch part 300 to the engaging part 220.

The paper tube cap 400 is engaged to the top of the paper tube body 100 and covers the pumping member 200 for thereby protecting the pumping member 200 from external impacts, which results in preventing erroneous operations of the pumping member 200.

In the present invention, the paper tube cap 400 is made from a paper material. Since the paper tube cap 400 is made from a paper material, it can be recycled when its lifespan is over for thereby preventing environment destruction.

The exchanges of the pouch of the contents refillable paper tube contain according to the preferred embodiments of the present invention will be described with reference to FIGS. 1 to 3.

As best seen in FIGS. 1 to 3, when the contents are all consumed, the user holds the pumping member 200 and lifts it up and disengages from the paper tube body 100. At this time, the pouch part 300 engaged to the engaging part 220 of the pumping member 200 is disengaged together.

When the pumping member 200 moves upward, and the pouch part 300 is disengaged from the paper tube body 100, the user rotates the fixing part 320 of the pouch part 300 in one direction for thereby disengaging the pouch part 300 from the engaging part 220, and the pouch part 300 full of new contents is engaged to the engaging part 220 for thereby finishing the exchange of the pouch part 300.

When the exchange of the pouch part 300 is finished, the pumping member 200 is engaged to the paper tube body 100. When the pumping member 200 is pressurized from the top of the paper tube body 100 to the lower side, the engaging groove 210 of the pumping member 200 is slowly engaged to the paper tube body 100 and is mounted on the top of the paper tube body 100, so it is interference-fitted into the paper tube body 100. At this time, the paper tube body 100 should be thick enough to prevent any transformation when the paper tube body 100 is interference-fitted into the pumping member 200 because it may be transformed thanks to a flexible paper material.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A contents refillable paper tube container, comprising:
a paper tube body (100) which is made from a paper material and has a space in which to store contents;
a pumping member (200) which has an engaging groove (110) mounted on the top of the paper tube body (100) while covering the top of the paper tube body (100) and being detachable from the paper tube body (100) and has an engaging part (220) formed at its lower side and having threads (221), for thereby discharging contents to the outside through a pumping operation as a user pressurizes;
a pouch part (300) which stores contents and is detachable from the engaging part (220) for the sake of its exchange when the contents are all consumed; and
a paper tube cap (400) which is made from a paper material and is engaged covering the pumping member (200) at the top of the paper tube body (100).

2. The container of claim 1, wherein the pouch part (300) comprises:
a pouch (310) which stores contents;
a fixing part (320) which supports the pouch (310) and has an opening (321) at its center for charging contents through the opening (321) and threads (322) formed at its outer surface for a thread engagement to the engaging part (220); and
a pressurization part (330) which is engaged to the opening (321) at the top of the fixing part (320) and has a hollow portion (331) for charging contents.

3. The container of claim 2, wherein the top of the pouch (310) is mounted on the top of the fixing part (320) and is fixed as the pressurization part 330 pressurizes.

4. The container of claim 2, wherein a fixing shoulder (323) is formed at the top of the fixing part (320) so as to prevent the pouch (310) from being disengaged, and a pressurization protrusion (332) is formed at the pressurization part 330 for pressurizing and fixing the pouch (310).
